(19) United States
(12) Patent Application Publication
(10) Pub. No.: US 2009/0024742 A1
(43) Pub. Date: Jan. 22, 2009

(54) Distribution of Multimedia Files Using a Roving File Server

(75) Inventors: Toby John Bowen, Durham, NC (US); Anthony J. Sammarco, Raleigh, NC (US); Walter M. Marcinkiewicz, Chapel Hill, NC (US); Charles Liu, Chapel Hill, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/778,354

(22) Filed: Jul. 16, 2007

(51) Int. Cl. G06F 15/173; H04H 7/04

(52) U.S. Cl. 709/226

(57) ABSTRACT

Methods and apparatus for distributing multimedia files to wireless-equipped subscriber units are disclosed. In an exemplary method, a multimedia title is associated with a subscriber unit and a multimedia file corresponding to that multimedia title is downloaded to a roving file server using a broadband communications link. After the roving file server detects that it is within range of a wireless transceiver associated with the subscriber unit, the multimedia file is transferred to the subscriber unit using the detected wireless transceiver.

### BACKGROUND

The present invention relates generally to the distribution of multimedia files to wireless subscriber units, and more particularly relates to distributing multimedia files using a roving file server.

With the continuously evolving capabilities of the Internet, consumers and their Internet-enabled devices are developing growing appetites for bandwidth-intensive applications. One of these applications is the distribution of multimedia files, such as short movie clips or even full-length feature films.

Wireless network technology is also evolving rapidly, although the bandwidths currently available for multimedia applications tend to lag behind those available in fixed networks. Wide-area wireless networks, such as Wideband CDMA networks conforming to standards developed by the 3^{rd} Generation Partnership Project (3GPP), are evolving to offer increased bandwidth, and promise to support varied multimedia applications. At the same time, advanced local-area wireless technology is also evolving, with even greater bandwidth capabilities.

Although wide-area wireless networks are offering increased bandwidth, the ultimate capacity of these networks is limited by practical considerations. In particular, the capacity is limited by the rate of re-use of wireless spectrum. This re-use can be increased by increasing the complexity of the wireless technology, increasing the number of base stations used, or both. Either approach imposes significant costs, such that downloading large multimedia files over these wide-area networks may be prohibitively costly for many applications. In addition, the roll-out of advanced wide-area wireless network technology may be uneven, so that access to large bandwidths may be unavailable in many locations at any given time.

On the other hand, local area technologies, such as wireless local area network (W-LAN) technology, tend to be less expensive. However, the range of these technologies is limited, and conventional technologies require that the wireless access point be fixed, and connected to a wired Internet access point, in order to provide real-time access to the broad range of applications available on the Internet. Thus, although transferring multimedia files to a subscriber device using wireless local area technologies is fast and cost effective, availability depends upon whether the subscriber is within range of a fixed access point.

### SUMMARY

Methods and apparatus for distributing multimedia files to wireless-equipped subscriber units are disclosed. In an exemplary method, a multimedia title is associated with a subscriber unit and a multimedia file corresponding to that multimedia title is downloaded to a roving file server using a broadband communications link. After the roving file server detects that it is within range of a wireless transceiver associated with the subscriber unit, the multimedia file is transferred to the subscriber unit using the detected wireless transceiver.

A multimedia title may be associated with a subscriber unit in response to a specific request for that title. Alternatively, the association may be based upon a profile corresponding to the subscriber unit, a subscriber history corresponding to the subscriber unit, or both.

In one or more embodiments, the multimedia file is downloaded to a roving file server selected from a plurality of candidate roving file servers, based upon a planned route for the roving file servers.

### BRIEF DESCRIPTION OF THE DRAWINGS

FIG. 1 illustrates components of a system for distributing multimedia files in accordance with one or more embodiments of the invention.

FIG. 2 is a flow diagram illustrating an exemplary method for distributing multimedia files using a roving file server.

FIG. 3 is a block diagram for a roving file server.

FIG. 4 illustrates communication between peer roving file servers in accordance with one or more embodiments of the invention.

FIG. 5 illustrates a subscriber unit in accordance with one or more embodiments of the invention.

### DETAILED DESCRIPTION

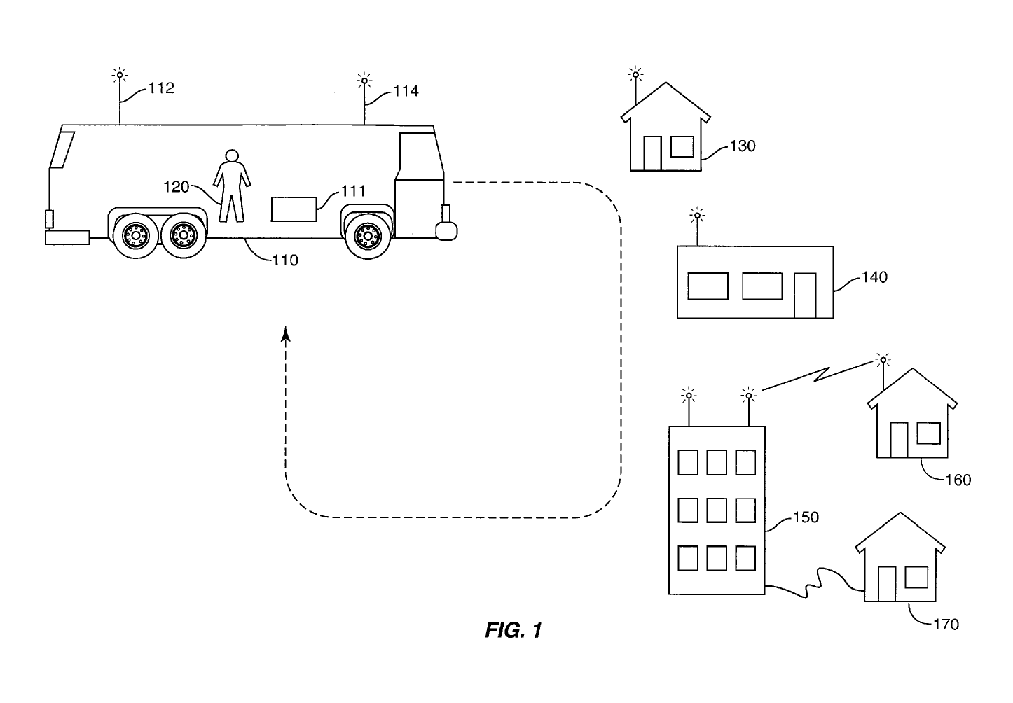

FIG. 1 provides an overview of an approach to distributing multimedia files in accordance with the present invention. In FIG. 1, a vehicle 110, such as a public bus, carries a roving file server 111, which is connected to a broadband communications antenna 112 and a short-range wireless antenna 114. As will be explained more fully below, passenger 120 may be carrying a portable wireless device (not shown) capable of establishing a short-range wireless connection with the roving file server 111 via the short-range wireless antenna 114.

The roving file server 111 is configured to access multimedia files via the broadband communications antenna 112. Broadband communications antenna 112 provides a link to one or more of a variety of broadband wireless networks. Non-limiting examples include terrestrial networks employing WiMAX technology, 3^{rd}- or 4^{th}-generation cellular telephone technology, or point-to-point microwave technology. Broadband communications antenna 112 might also provide access to multimedia files via satellite communications technology.

In an alternative embodiment, broadband communications antenna 112 may be replaced or supplemented with an interface facilitating physical connection to a wired network, such as an Ethernet network. Although this physical interface is not usable while the bus 110 is traveling, it may be employed when the bus 110 is at a depot, for example, or when the bus 110 is otherwise at rest and can be connected to a wired network.

The roving file server 111 of FIG. 1 is configured to download multimedia files, via the broadband communications antenna 112, from a fixed server on the Internet, and to store those files in memory for later distribution. Those skilled in the art will recognize that various means for downloading multimedia files via a broadband communications link are possible. For example, broadband communications antenna 112 may alternatively provide access to a private network containing a file server, which may be isolated from the Internet by a firewall or not connected to the Internet at all. Another embodiment might employ virtual-private-network (VPN) technology, thus enjoying the benefits of widespread coverage provided by Internet access points while also retaining many of the security features of a private network.

As the bus 110 travels along its route, it comes within range of various subscriber units equipped with short-range wireless technology. FIG. 1 illustrates a subscriber unit installed at a residence 130 and a business 140. As will be explained further, roving file server 111 is configured to detect that a subscriber unit is within range, and to transfer multimedia files stored in memory to the detected subscriber unit. For example, upon detecting that residence 130 is within range, roving file server 111 transfers one or more multimedia files to the subscriber unit at residence 130, utilizing the short-range wireless antenna 114. These may be multimedia files that a subscriber has requested, or files that have been selected for the subscriber based on user preferences, user history, or both.

Roving file server 111 may employ one or more of several short-range wireless technologies in transferring multimedia files. Non-limiting examples include Bluetooth technology, W-LAN technology (including technologies conforming to standards such as the 802.11 family of standards promulgated by the Institute of Electrical and Electronics Engineers), and ultra-wideband (UWB) technology.

The maximum range over which a multimedia file can be transferred will depend upon the particular technology or technologies employed by roving file server 111 and the subscriber units. In some cases, subscribers may be located near a route traveled by bus 110, but nonetheless out of range of short-range wireless antenna 114. In this case, multimedia files are transferred to an intermediate site 150 for subsequent delivery to the subscriber. This subsequent delivery may be accomplished in several different ways. For example, as shown in FIG. 1, after a multimedia file has been transferred to intermediate site 150 it may be delivered to a subscriber located in residence 160 via another wireless link. Another subscriber, located in residence 170, may receive multimedia files from intermediate site 150 via a wired link, such as via an Ethernet connection.

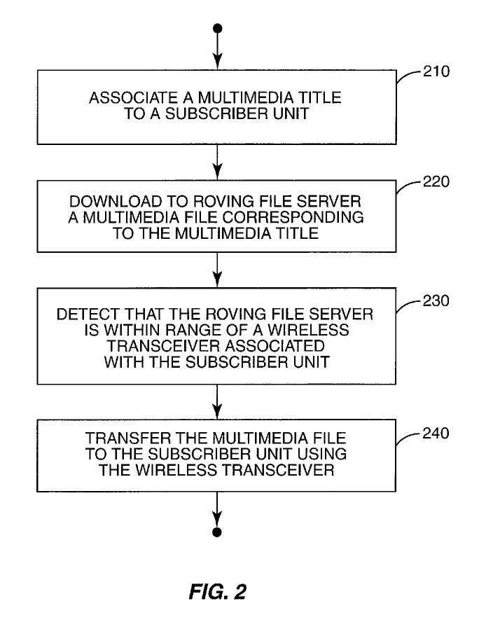

An exemplary method for distributing multimedia files to a subscriber unit is illustrated in FIG. 2. At block 210, a multimedia title is associated to a subscriber unit. As used herein, “multimedia title” refers to any means for referencing a multimedia file. Thus, a multimedia title may comprise a filename, a title for a film or video clip, a uniform resource identifier (URI) or locator (URL), or the like.

At block 220, a multimedia file corresponding to the multimedia title is downloaded to the roving file server 111. As described above, the multimedia file is downloaded to the roving file server 111 by way of a broadband connection, such as by way of the broadband communications antenna 112 shown in FIG. 1.

At block 230, the roving file server 111 detects that it is within range of a wireless transceiver unit associated with the subscriber unit. In many cases, the subscriber unit itself includes a short-range wireless transceiver, such as a W-LAN transceiver. Several such scenarios may be readily understood by referring to FIG. 1. For example, passenger 120 may be carrying a portable computer that includes W-LAN or other short-range wireless capability. Assuming that roving file server 111 is equipped with compatible wireless technology, then roving file server 111 can detect the presence of the passenger's computer when the computer attempts to establish a connection with roving file server 111. Similarly, roving file server 111 detects W-LAN transceivers (or other short-range wireless transceivers) at residence 130, business 140, or intermediate site 150, as bus 110 passes by on its route. These detected transceivers may be access points, to which portable subscriber units are in turn wirelessly connected. Or, one or more of these detected transceivers may be built into portable subscriber units, such as mobile telephones or laptop computers.

At block 240, the roving file server 111 transfers the multimedia file to the subscriber unit via the short-range wireless transceiver detected at block 230. In those cases, such as those described above, where the detected wireless transceiver is built into a subscriber unit, then the transfer can be accomplished directly. In other scenarios, such as where the detected wireless transceiver is an access point to which a subscriber unit is wirelessly connected, the transfer is accomplished via that access point.

In one or more embodiments of the invention, subscribers are provided with an interactive catalog of available multimedia titles. Specific titles requested by the subscriber from the interactive catalog are then associated with the requesting subscriber's subscriber unit.

The catalog may be provided to the subscriber unit by the same means used for ultimately delivering the multimedia files, i.e. by way of the short-range wireless antenna 114 when the bus 110 is within range of the subscriber unit. In this case, the catalog may include titles for multimedia files already stored in the roving file server, as well as titles for files that are not immediately accessible, but that can be downloaded when the roving file server 111 next establishes a broadband connection using broadband communications antenna 112. Thus, subscribers browsing the catalog may in some cases be able to receive “on-demand” service, at least for a limited set of multimedia titles. Other titles may be requested immediately, but will not be delivered until a later time.

In other embodiments, subscribers may request titles by indirect means. For example, a subscriber may access a web site associated with a multimedia file delivery service, using a conventional Internet connection. At the web site, the subscriber selects one or more multimedia titles that it wishes to receive. Optionally, the subscriber provides profile information that the file delivery service can use to recommend titles to the subscriber, or to predict future requests. This profile information may include such information as user preferences, such as for particular genres of multimedia files. The profile information might also include information as to multimedia titles that were previously requested or viewed. Subsequent requests may be used to update a subscriber profile, allowing the delivery service to make improved predictions as to the multimedia titles a subscriber is most likely to enjoy.

A request entered by a subscriber at the web site is relayed to the roving file server 111 by way of the broadband connection, e.g. via the broadband communications antenna 112. If the multimedia file associated with the requested title is not already stored in the roving file server 111, then the multimedia file is downloaded to the roving file server 111. In either case, the request causes the roving file server 111 to be updated so that the multimedia file is associated with the subscriber unit belong to the requesting subscriber.

Because the roving file server 111 may not have immediate access to the broadband connection when a request for a multimedia title is received, it may be desirable to predict a subscriber request or preference, and pre-load one or more multimedia files for a subscriber. This prediction may be based on a subscriber profile, a subscriber usage history, or both. Several multimedia files corresponding to explicitly stated or inferred subscriber preferences may thus be downloaded to the roving file server 111 while it has access to the broadband connection, even absent a subscriber request for those titles. In this manner, when the roving file server 111 later encounters the subscriber, it is able to offer immediate access to one or more multimedia files of interest to the subscriber.

Typically, a service provider offering multimedia file distribution according to the methods specified herein will maintain its primary servers and file storage on a fixed network, i.e., separate from roving file server 111. Thus, roving file server 111 serves as a delivery mechanism for fulfilling requests and/or preferences for multimedia titles from subscribers. In many cases, the service provider may have several roving file servers 111. For example, a service provider may have roving file servers installed in each of fleet of buses operated by a municipality.

Depending on the number of subscribers, the number of requested multimedia titles, and the file storage available on a roving file server 111, it may be impractical to download multimedia files for all pending requests to each and every roving file server 111 in a given area. Thus, an originating file server must often choose to download a multimedia file to less than all of a plurality of available roving file servers 111.

In some cases, the roving file server 111 is selected by virtue of its route. For example, if a subscriber request originated from a fixed address, such as residence 130 of FIG. 1, then the multimedia file corresponding to that request is downloaded to one or more roving file servers 111 that are expected to travel near residence 130 on their usual routes.

In other cases, access to a particular subscriber might not be at a fixed address, but at a predictable time and/or place. For example, a commuter may tend to use the same public bus, or a limited subset of all available buses, on a daily basis. This bus may vary from the morning to the evening commutes. Accordingly, a multimedia title request from that commuter may be fulfilled by downloading the requested multimedia file to one or more buses that are expected to encounter that commuter within a reasonable period of time.

The roving file server 111 may detect that it is within range of a subscriber unit's wireless transceiver in one of several ways. First, the roving file server 111 or the subscriber unit's wireless transceiver, or both, may be configured to operate in a “discovery” mode. This discovery mode may be in accordance with an industry standard applicable to the particular short-range wireless technology. Typically, discovery involves a “sniffing” or scanning operation, where a wireless receiver searches for signals transmitted by nearby transmitters. Upon receipt of such a signal, an access procedure begins. This access procedure may commence with an unsolicited access request from the roving file server 111 to the subscriber unit's wireless transceiver, or vice-versa. Those skilled in the art will be familiar with service discovery mechanisms utilized by various short-range wireless technologies.

In some cases, such as when a subscriber unit is associated with a fixed physical address, the roving file server 111 can initiate a connection with a subscriber unit's wireless transceiver when it comes into range, without “sniffing” for the subscriber unit's wireless signal. For example, a subscriber operating a wireless access point at his residence may choose not to broadcast identifying signals over the air. If the roving file server 111 is configured to receive current location information, e.g. from a GPS receiver located on the bus 110, then it can compare its current location to a known location for the subscriber. Upon reaching a point known to be within range of the subscriber's wireless transceiver, the roving file server 111 may initiate a connection with the wireless transceiver and transfer requested multimedia files.

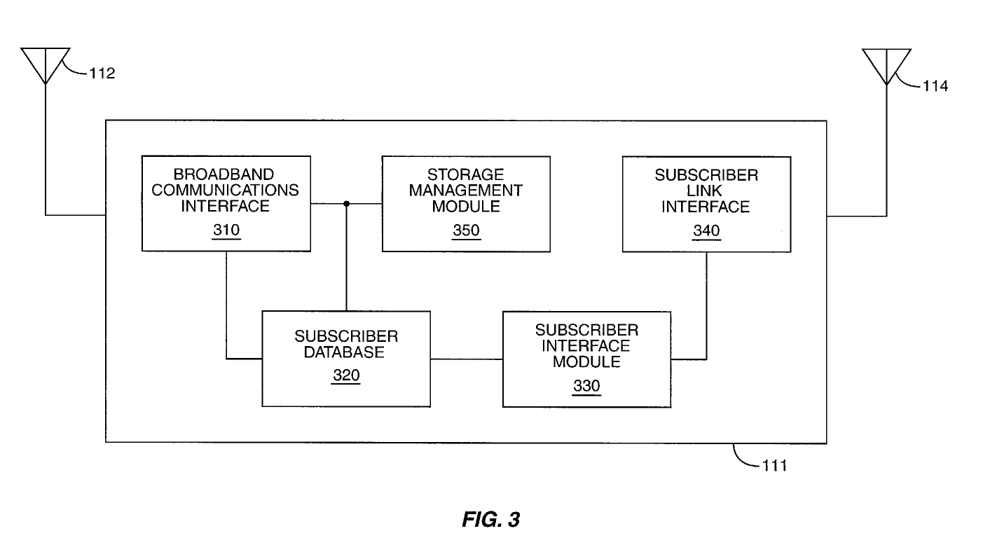

FIG. 3 illustrates functional components of a roving file server 111 in accordance with one or more embodiments of the present invention. Roving file server 111 comprises a broadband communications interface 310, a subscriber database 320, a subscriber interface module 330, a subscriber link interface 340, and a storage management module 350. Roving file server 111 is connected to broadband communications antenna 112 and short-range wireless antenna 114, typically through intervening radio-frequency circuitry (not shown).

Broadband communications interface 130 comprises hardware and software (including firmware, in some instances) configured to establish connection to an external network via a broadband communications link. As discussed earlier, this broadband communications link may employ terrestrial wireless technologies or even satellite technology. In other embodiments, broadband communications interface 130 may be configured to connect to a network via a wired connection, using a network connector that supplements or replaces broadband communications antenna 112.

Broadband communications interface 130 will typically comprise standard-specific hardware and software for establishing and maintaining data communications sessions with external servers via the broadband communications link. Broadband communications interface 130 also comprises a processor configured to manage those communications sessions, and to manage the downloading of multimedia files to the subscriber database 320.

Subscriber database 320 comprises a memory storage unit. Any of various types of memory suitable for storing large quantities of data may be used, including flash memory, disk drives, and the like. Those familiar with the state of the art will be familiar with the advantages and disadvantages accruing to each type, including factors such as cost, size, and power requirements.

In addition to storing downloaded multimedia files, subscriber database 320 is also configured to store data associating multimedia titles with subscriber units. As discussed above, this association results from a specific request from a subscriber for a particular title, or may result from a prediction of a subscriber interest.

Subscriber link interface 340 is configured to discover wireless transceivers associated with subscriber units, to establish and maintain communications links with those wireless transceivers, and to manage the transfer of multimedia files from the subscriber database 320 to the subscriber unit, under the control of the subscriber interface module 330. As with the broadband communications interface 310, the subscriber link interface 340 comprises hardware and software, typically configured to conform to one or more industry standards. As discussed above, the subscriber link interface 340 may utilize any of a variety of short-range wireless technologies, including W-LAN, Bluetooth, UWB, and the like.

Subscriber interface module 330 is configured to manage subscriber requests and to initiate the transfer of multimedia files stored in subscriber database 320 to the associated subscriber unit, via subscriber link interface 340. Subscriber interface module 330 is thus configured to process multimedia title requests received from a subscriber. As discussed above, these requests may have been received earlier, in which case a multimedia file associated with the subscriber unit will have been downloaded to subscriber database 320 along with data associating the file to the subscriber unit.

In one or more embodiments, subscriber interface module 330, which is implemented as software running on a general-purpose microprocessor, is also configured to receive requests for multimedia titles from in-range subscriber units, and to update the subscriber database accordingly. In some cases, the file corresponding to a requested title may already be stored in subscriber database 320, in which case the subscriber interface module 330 may initiate an immediate transfer of the file via the subscriber link interface. In other cases, the corresponding file is not immediately available, in which case the request is stored until it can be uploaded to the service provider via the broadband communications interface and a corresponding multimedia file downloaded.

Subscriber interface module 330 is also configured to manage interactive sessions with subscribers, when those subscribers are within range. Subscriber interface module 330 can transfer a catalog, or menu, of available titles to the subscriber unit, and receive specific title requests. Subscriber interface module 330 may also be configured to suggest titles that have been pre-loaded into subscriber database 330. These suggestions may be based on a subscriber profile, a subscriber usage history, or both.

Because storage available in subscriber database 320 is limited, roving file server 111 also includes a storage management module 350, which is implemented as software running on the same processor as used for subscriber interface 330. Storage management module 350 ensures that the memory available in subscriber database 320 is used efficiently. For example, only a portion of subscriber database 320 may be necessary at any given time to store multimedia files that have been specifically requested. In order to increase the probability that desirable content is available even for unexpected customers, storage management module 350 is configured to download additional multimedia files (via broadband communications interface 310) to be available for on-demand requests.

Storage management module 350 thus keeps track of the downloaded multimedia files, including those corresponding to specific requests, and maintains storage management information indicating the status of the subscriber database 320 at any given time. Storage management module 350 is also configured to determine when a stored multimedia file is no longer needed, and to selectively delete files to make room for new multimedia files to be downloaded. Storage management module 350 may select a file for deletion because it has already been transferred to a requesting subscriber. Alternatively, storage management module 350 may select for deletion files that were never specifically requested, but were downloaded only in anticipation of subscriber preferences.

The storage management information maintained by storage management module 350 may include “popularity” data indicating whether or how often a particular multimedia title has been requested. In addition, the information may indicate whether a particular multimedia title has been requested by a peer roving file server, and, if so, how often. This enhanced storage management information may be used by the storage management module 350 to determine which files to delete when file storage space must be freed for new files. Files corresponding to particularly “popular” titles, such as those titles frequently requested by peer roving file servers, are favored over less popular titles, and are kept in storage longer.

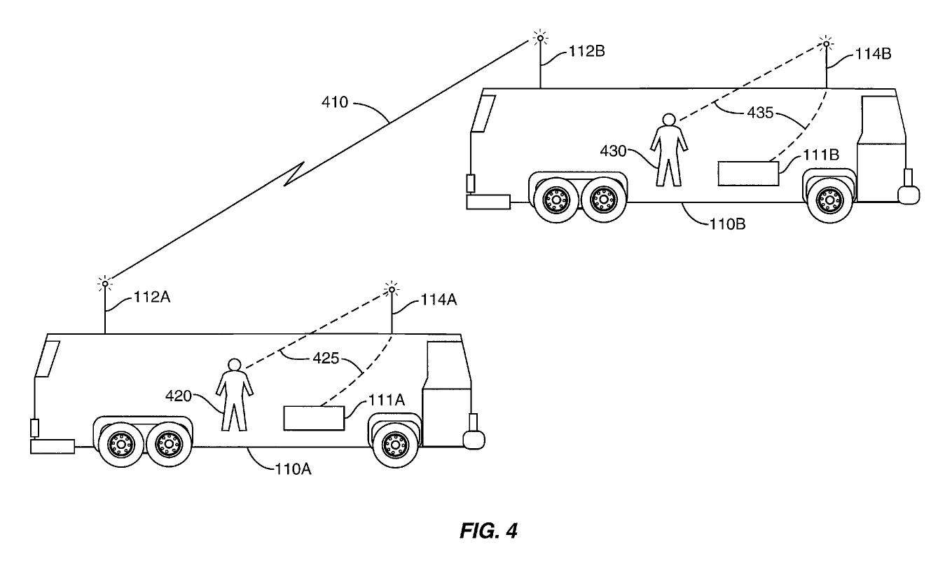

Although a roving file server 111 may generally download multimedia files from a fixed server, files may also be downloaded to one roving file server 111 from another. This is illustrated in FIG. 4.

In FIG. 4, bus 110A, carrying roving file server 111A, has established a communications link 410 with roving file server 111B, carried by bus 110B. The buses 110A and 110B carry passengers 420 and 430 respectively. In the embodiment shown in FIG. 4, the connection between roving file servers 111A and 111B is established via broadband communications antennas 112A and 112B, the same antennas over which connections to a fixed network, e.g. the Internet, are made. In other embodiments, roving file servers 111A and 111B establish wireless connections with each other using a different wireless technology than that employed for downloading multimedia files from a fixed network. In some cases, the connection between roving file servers 111A and 111B may be established using the same short-range technology as is used for connections to subscriber units.

FIG. 4 thus illustrates one scenario for delivering a multimedia file to a subscriber unit. Passenger 420, carrying a wireless-equipped subscriber unit, has established a connection 425 with roving file server 111A, via antenna 114A. Roving file server 111A has received a request for a specific multimedia title, but the corresponding multimedia file is not currently stored at roving file server 111A. Via the peer-to-peer connection 410, roving file server 111A is able to inquire as to whether the requested file is stored at roving file server 111B. If it is, then roving file server 111A can download the multimedia file via peer-to-peer connection 410 and transfer the file to the subscriber unit held by passenger 420, using a short-range wireless technology and connection 425.

In addition to downloading multimedia files from a peer, roving file servers 111A and 111B may also be configured to download files from subscriber units. In the scenario described above, for example, roving file server 111A inquires with roving file server 111B as to a specific multimedia title. If the file corresponding to that title is not stored at roving file server 111B, roving file server 111B may in turn inquire with the subscriber unit held by passenger 430. If that subscriber unit has the requested file, then the file is downloaded to roving file server 111B via connection 435, downloaded by roving file server 111A over connection 410, and finally transferred to the subscriber unit held by passenger 420 over connection 425.

As an alternative to specific inquiries sent by roving file servers 111A and 111B to peer roving file servers and to proximate subscriber units, roving file servers 111A and 111B and subscriber units can be configured to share their contents with each other upon establishing a connection. In this manner, each unit is “aware” of all multimedia files that may be retrieved from nearby units if necessary. This shared content information may be made available to subscriber units, so that, for example, passenger 420 may make an “on-demand” selection of a multimedia file currently stored at peer roving file server 111B, or of a multimedia file stored at the subscriber unit held by passenger 430.

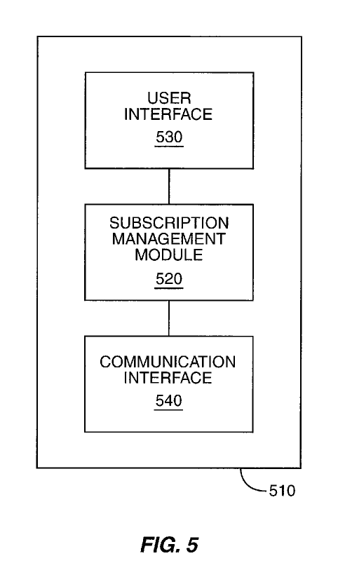

FIG. 5 illustrates a subscriber unit 510 configured in accordance with one or more embodiments of the present invention. Subscriber unit 510 comprises a subscription management module 520, a user interface 530, and a communications interface 540. Subscriber unit 510 may be implemented in a variety of portable and fixed devices, such as wireless telephones, personal digital assistants (PDAs), laptop computers, residential gateways, and so on.

Subscription management module 520, implemented as software running on a general-purpose or specialized microprocessor, is configured to retrieve a catalog of multimedia files available for delivery to the subscriber unit. This catalog may be retrieved directly from a roving file server 111, when the roving file server 111. Alternatively, the catalog may be retrieved from a fixed server on the Internet, using any network connection available to the device.

Subscriber unit 510 also includes a user interface 530, which is configured to display all or part of the catalog, and to accept user selection of a multimedia title from the catalog. In most implementations, user interface 530 is shared with other functions of the subscriber device. For example, user interface 530 may comprise the screen and small keypad of a mobile telephone. Alternatively, user interface 530 may comprise the display and full keyboard of a laptop computer.

Subscriber unit 510 also includes a communications interface 540, which is configured to determine that a wireless transceiver at roving file server 111 is within range, and to establish a communications link with roving file server 111. Communications interface 540 uses one of several possible short-range wireless transceiver technologies, as discussed above. Communications interface 540 determines that roving file server 111 is within range using discovery methods appropriate for the particular short-range wireless technology employed.

Upon establishing the connection, the communications interface 540 downloads a selected multimedia title from the roving file server 111, using the wireless transceiver. If the multimedia title is not immediately available from the roving file server 111, then communications interface 540 issues a request to the roving file server 111 for the title. This request may later be fulfilled by roving file server 111 using any of the methods discussed above.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for distributing multimedia files, comprising:
associating a multimedia title with a subscriber unit;
downloading to a roving file server a multimedia file corresponding to the multimedia title using a broadband communications link;
detecting that the roving file server is within range of a wireless transceiver associated with the subscriber unit; and
transferring the downloaded multimedia file to the subscriber unit using the wireless transceiver.

2. The method of claim 1, wherein associating a multimedia title with the subscriber unit comprises receiving a request for the multimedia title from the subscriber unit.

3. The method of claim 1, wherein associating a multimedia title with a subscriber unit comprises selecting the multimedia title based on a profile corresponding to the subscriber unit, a subscriber history corresponding to the subscriber unit, or both.

4. The method of claim 1, further comprising selecting the roving file server from a plurality of candidate roving file servers based upon a planned route for the roving file server.

5. The method of claim 1, further comprising selecting the roving file server from a plurality of candidate roving file servers based upon a predicted proximity of the roving file server to the subscriber unit.

6. The method of claim 1, wherein downloading to a roving file server a multimedia file corresponding to the multimedia title using a broadband communications link comprises retrieving the multimedia file from a fixed server via the broadband communications link.

7. The method of claim 1, wherein downloading to a roving file server a multimedia file corresponding to the multimedia title using a broadband communications link comprises:
receiving from a peer roving file server information describing one or more files stored on the peer roving file server, wherein the peer roving file server includes the multimedia file; and
copying the multimedia file to the roving file server.

8. The method of claim 1, wherein detecting that the roving file server is within range of a wireless transceiver comprises receiving an unsolicited message from the wireless transceiver.

9. The method of claim 1, wherein detecting that the roving file server is within range of a wireless transceiver comprises comparing a current location of the roving file server to a known location for the subscriber unit to determine whether the roving file server is within range.

10. The method of claim 1, wherein transferring the downloaded multimedia file to the subscriber unit comprises sending, via the wireless transceiver, the downloaded multimedia file to a distribution node associated with the subscriber unit for subsequent delivery to the subscriber unit.

11. A roving file server for distributing multimedia files, comprising:
a subscriber database comprising subscriber identities and associated multimedia titles;
a broadband communications interface configured to download one or multimedia files corresponding to the multimedia titles using a broadband communications link; and
a subscriber link interface configured to:
determine that the roving file server is within range of a wireless transceiver associated with a subscriber unit; and
transfer one or more of the downloaded multimedia files to the subscriber unit using the wireless transceiver.

12. The roving file server of claim 11, further comprising a subscriber interface module configured to receive a request for a multimedia title from the subscriber unit and to update the subscriber database based upon the request.

13. The roving file server of claim 12, wherein the subscriber interface module is configured to receive the request via the subscriber link interface when the roving file server is within range of the wireless transceiver.

14. The roving file server of claim 13, wherein the subscriber interface module is further configured to send to the subscriber unit a menu of multimedia titles, wherein the requested multimedia title is selected from the menu of multimedia titles.

15. The roving file server of claim 14, wherein the menu of multimedia titles is adapted based on a subscriber profile, a subscriber history, or both.

16. The roving file server of claim 12, wherein the subscriber interface module is configured to receive the request via the broadband communications interface.

17. The roving file server of claim 12, wherein the subscriber interface module is configured to select a multimedia title for association with the subscriber unit based on a profile corresponding to the subscriber unit, a subscriber history corresponding to the subscriber unit, or both, and wherein the subscriber interface module is further configured to update the subscriber database based on the selected multimedia title.

18. The roving file server of claim 11, wherein the broadband communications interface is configured to download the one or more multimedia files from a fixed server.

19. The roving file server of claim 11, wherein the broadband communications interface is configured to receive information from a peer roving file server describing multimedia files stored on the peer roving file server, and wherein the broadband communications interface is further configured to download the one more multimedia files from the peer roving file server.

20. The roving file server of claim 11, wherein the subscriber link interface is configured to determine that the roving file server is within range of the wireless transceiver by comparing a current location of the roving file server to a known location for the subscriber unit.

21. The roving file server of claim 11, wherein the subscriber link interface is configured to determine that the roving file server is within range of the wireless transceiver by receiving an unsolicited message from the wireless transceiver.

22. The roving file server of claim 11, wherein the subscriber link interface is configured to transfer the one or more of the downloaded multimedia files to the subscriber unit by sending, via the wireless transceiver, the one or more downloaded multimedia files to a distribution node associated with the subscriber unit for subsequent delivery to the subscriber unit.

23. The roving file server of claim 11, further comprising a storage management module configured to maintain storage management information associated with the downloaded multimedia files, and to selectively delete downloaded multimedia files based on the storage management information.

24. The roving file server of claim 23, wherein the storage management information includes popularity data corresponding to one or more of downloaded multimedia files, and wherein the storage management module is configured to selectively delete downloaded multimedia files based on the popularity data.

25. A subscriber unit for use in a multimedia delivery system, comprising:
a subscription management module configured to retrieve a catalog of multimedia files available from the multimedia delivery system;
a user interface configured to display all or a portion of the catalog and to accept user selection of a multimedia title from the catalog; and
a communications interface configured to
determine that the subscriber unit is within range of a wireless transceiver associated with a roving file server; and
selectively either download the multimedia file from the roving file server using the wireless transceiver or request the multimedia title, based on whether a multimedia file associated with the selected multimedia title is available on the roving file server.
